(19) United States
(12) Patent Application Publication
(10) Pub. No.: US 2008/0084044 A1
(43) Pub. Date: Apr. 10, 2008

(54) Portable step apparatus

(76) Inventor: Frederick L. Dietelbach, Findlay, OH (US)

Correspondence Address: JAMES RAY & ASSOCIATES, 2640 Pitcairn Road, Monroeville, PA, 15146, US

(21) Appl. No.: 11/906,402

(22) Filed: Oct. 2, 2007

Related U.S. Application Data
(60) Provisional application No. 60/828,119, filed on Oct. 4, 2006.

(51) Int. Cl. B60R 3/00; E06C 7/08

(52) U.S. Cl. 280/165; 182/92

(57) ABSTRACT

A portable step apparatus capable of supporting a predetermined weight and provide access to at least one of a windshield and an engine compartment of a predetermined vehicle includes an elongated step like member. An elongated strap like member is securable to the step like member adjacent a back portion thereof for encircling a portion of a tire disposed on such vehicle and to provide a first portion of support for the step like member. Lastly, there is a mechanism provided which engages the step like member adjacent a front portion thereof and a pre-selected member disposed in such engine compartment for providing a second portion of support for the step like member.

### CROSS REFERENCE TO RELATED APPLICATION

This patent application is related to and claims priority from U.S. Provisional Patent Application Ser. No. 60/828,119 filed Oct. 4, 2006.

### FIELD OF THE INVENTION

The present invention relates, in general, to steps and, more particularly, this invention relates to a portable step apparatus capable of supporting a predetermined weight and provide easy access to at least one of a windshield and an engine compartment of a predetermined vehicle.

### BACKGROUND OF THE INVENTION

Prior to the conception and development of the present invention, as is generally well known in the prior art, drivers and operators of trucks or other heavy equipment must climb up and stand on the tire of such trucks or heavy equipment to either clean a windshield on the vehicle or check something with respect to the equipment in the engine compartment or use portable step ladders.

Standing on a vehicle tire can be a rather dangerous chore, particularly, if the tire has little or no tread thereon. This condition is can be even more dangerous if such tire is wet. On the other hand, the equipment such as portable step ladders presently available to stand on take up considerable amount of room and are therefore not normally used.

### SUMMARY OF THE INVENTION

The present invention provides a portable step apparatus capable of supporting a predetermined weight and allows relatively easy access to at least one of a windshield and an engine compartment of a predetermined vehicle. The portable step apparatus includes an elongated step like member having each of a first predetermined length, a first predetermined width and a predetermined depth. An elongated strap like member engages with and is secured to such step like member adjacent a back portion thereof for encircling a predetermined portion of a tire disposed on such pre-selected vehicle and to provide a first portion of support for the step like member. Such elongated strap like member has each of a second predetermined length and a second predetermined width. Additionally, there is a first means engageable with and securable to the step like member adjacent a front portion thereof and to a pre-selected member disposed in such engine compartment of such pre-selected vehicle for providing a second portion of said support for said step like member.

### OBJECTS OF THE INVENTION

It is, therefore, one of the primary objects of the present invention to provide a portable step apparatus for a predetermined vehicle which is relatively light weight.

Another object of the present invention is to provide a portable step apparatus for use on a predetermined vehicle which does not require a great deal of space when not in use.

Still another object of the present invention is to provide a portable step apparatus for use on a predetermined vehicle which is relatively inexpensive to manufacture.

Yet another object of the present invention is to provide a portable step apparatus for use on a predetermined vehicle which can be produced in a variety of sizes.

An additional object of the present invention is to provide a portable step apparatus for use on a predetermined vehicle which will substantially minimize the risk of injury when compared to prior art practices.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is perspective view of a presently preferred embodiment of portable step apparatus constructed according to the invention;

FIG. 2 is a side elevation view of the portable step apparatus illustrated in FIG. 1 as it is installed on a vehicle tire ready for use;

FIG. 3 is a top view of a presently preferred embodiment of the step portion of portable step apparatus according to the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

As used in the specification and claims the term vehicle is meant to include semi trailer tractors, other large trucks and heave construction and mining type equipment.

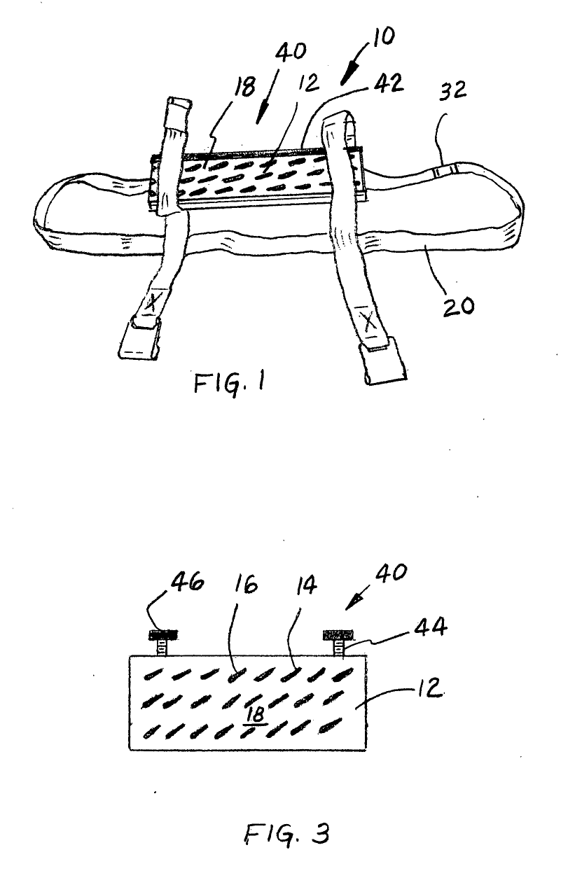

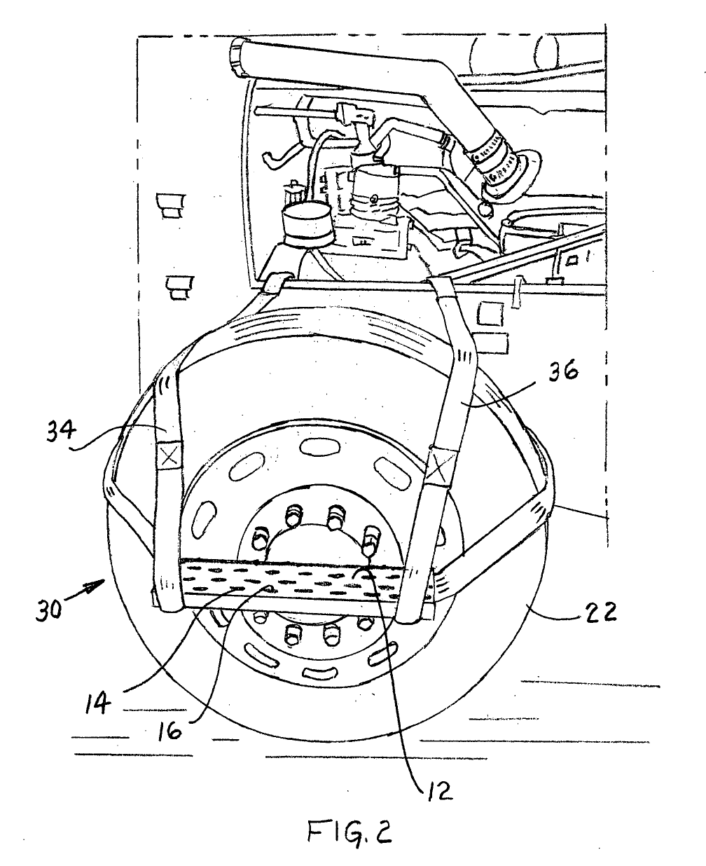

Reference is now made, more particularly, to FIGS. 1-3. Illustrated therein is a presently preferred embodiment of a portable step apparatus, generally designated 10. Such step apparatus 10 is capable of supporting a predetermined weight and provides relatively easy access to at least one of a windshield (not shown) and an engine compartment (not shown) of a predetermined vehicle (not shown). The portable step apparatus 10 includes an elongated step like member 12. Step like member 12 has each of a first predetermined length, a first predetermined width and a predetermined depth. In the presently preferred embodiment of the invention, the first predetermined length of such step like member 12 will generally be in a range of between about 18.0 inches and about 22.0 inches and the first predetermined width of such step like member 22 will generally be in a range of between about 6.0 inches and about 8.0 inches. Also, the first predetermined depth of step like member 12 will generally be in a range of between about 1.5 inches and about 2.5 inches.

An elongated strap like member 20 is engageable with and securable to the step like member 12 adjacent a back portion thereof for encircling a predetermined portion of a tire 22 disposed on such predetermined vehicle and for providing a first portion of support for the step like member 12. The portion of the tire 22 that is surrounded by the elongated strap like member 20 is preferably the upper portion. The elongated strap like member 20 includes each of a second predetermined length and a second predetermined width.

In the preferred embodiment of the invention, the elongated strap like member 20 includes an adjustment means for changing a length thereof. The adjustment means is preferably a buckle 32.

A first means, generally designated 30, engages with and is securable to the step like member 12 adjacent a front portion thereof and to a pre-selected member disposed in such engine compartment of such predetermined vehicle for providing a second portion of the support for the step like member 12.

In the most preferred embodiment of the instant invention, the portable step apparatus 10 will further include a non-skid surface formed by raised serrations 14 around openings 16 on an upper surface 18 thereof to substantially minimize slipping of a person standing on the step like member 12.

Additionally, portable step apparatus 10 further includes a second means, generally designated 40, engageable with a back surface of said step like member 12 and with such tractor's rim to prevent marring said rim when said portable step apparatus 10 is being used. The presently preferred means 40 includes a pair of bolts 44 having rubber tips 44 covering the ends thereof which engage the rim.

According to the presently preferred embodiment of the invention such first means 30 is a pair of strap like members 34 and 36, having each of a third predetermined length and a third predetermined width. Additionally, such third predetermined length of the pair of said strap like members 34 and 36 is adjustable in length and each of the second predetermined width of the elongated strap like member 30 and the third predetermined width of such pair of said strap like members 24 and 36 are substantially identical. Preferably, each of the second predetermined width of the elongated strap like member 30 and the third predetermined width of such pair of said strap like members 34 and 36 are generally between about 1.75 inches and about 2.25 inches. Further, the elongated strap like member 30 and the pair of said strap like members 34 and 36 are manufactured from nylon.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A portable step apparatus capable of supporting a predetermined weight and to provide easy access to at least one of a windshield and an engine compartment of a predetermined vehicle, said portable step apparatus comprising:
(a) an elongated step like member having each of a first predetermined length, a first predetermined width and a predetermined depth;
(b) an elongated strap like member engageable with and securable to said step like member adjacent a back portion thereof for encircling a predetermined portion of a tire disposed on such predetermined vehicle and for providing a first portion of support for said step like member, said elongated strap like member having each of a second predetermined length and a second predetermined width; and
(c) a first means engageable with and securable to said step like member adjacent a front portion thereof and to a pre-selected member disposed in such engine compartment of such predetermined vehicle for providing a second portion of said support for said step like member.

2. A portable step apparatus, according to claim 1, wherein said step like member includes a non-skid surface on an upper surface thereof to substantially minimize slipping of a person standing on said step like member.

3. A portable step apparatus, according to claim 2, wherein said first predetermined length of said step like member is generally between about 18.0 inches and about 22.0 inches.

4. A portable step apparatus, according to claim 3, wherein said first predetermined width of said step like member is generally between about 6.0 inches and about 8.0 inches.

5. A portable step apparatus, according to claim 4, wherein said first predetermined depth of said step like member is generally between about 1.5 inches and about 2.5 inches.

6. A portable step apparatus, according to claim 1, wherein said portable step apparatus further includes a second means engageable with a back surface of said step like member and with such tractor's rim to prevent marring said rim when said portable step apparatus is being used.

7. A portable step apparatus, according to claim 6, wherein said second means a screw and nut arrangement having rubberized tips attached thereto.

8. A portable step apparatus, according to claim 1, wherein said elongated strap like member includes an adjustment means for changing a length thereof.

9. A portable step apparatus, according to claim 8, wherein said adjustment means is a buckle.

10. A portable step apparatus, according to claim 8, wherein said predetermined portion of said tire is an upper portion.

11. A portable step apparatus, according to claim 6, wherein said first means is a pair of strap like members, having each of a third predetermined length and a third predetermined width.

12. A portable step apparatus, according to claim 6, wherein said third predetermined length of said pair of said strap like members is adjustable in length.

13. A portable step apparatus, according to claim 11, wherein each of said second predetermined width of said elongated strap like member and said third predetermined width of said pair of said strap like members are substantially identical.

14. A portable step apparatus, according to claim 11, wherein each of said second predetermined width of said elongated strap like member and said third predetermined width of said pair of said strap like members are generally between about 1.75 inches and about 2.25 inches.

15. A portable step apparatus, according to claim 11, wherein said elongated strap like member and said pair of said strap like members are manufactured from nylon.

16. A portable step apparatus, according to claim 11, wherein said predetermined vehicle is one of a tractor portion of a tractor trailer combination, a dump truck, a pick-up truck and heavy equipment.
